(19) United States
(12) Patent Application Publication
(10) Pub. No.: US 2010/0044074 A1
(43) Pub. Date: Feb. 25, 2010

(54) CARBON NANOTUBE NETWORKS WITH METAL BRIDGES

(76) Inventors: Yong Hyup Kim, Seoul (KR); Tae June Kang, Seoul (KR)

Correspondence Address: YONG HYUP KIM;ACROVISTA C-505, 1685-3 SEOCHO-DONG, SEOCHO-GU, SEOUL, 137-921, KR

(21) Appl. No.: 12/197,758

(22) Filed: Aug. 25, 2008

(51) Int. Cl. H01B 5/00

(52) U.S. Cl. 174/126.2; 427/466; 977/743

(57) ABSTRACT

Structures comprising a carbon nanotube (CNT) network and metal, as well as methods for making a CNT network structure, are provided.

### BACKGROUND

The present disclosure relates generally to the field of nanotechnology. Although carbon nanotubes (CNTs) have been utilized extensively in numerous applications due to their extraordinary physical properties, it is difficult to reproduce single CNT devices consistently because of the variation in the chirality and geometry of the CNTs. Such variation, however, is reduced in CNT networks due to the ensemble averaging over a large number of CNTs.

CNT networks are reproducible and can be fabricated at low cost and high efficiency by using simple processes such as dip-coating, spray coating, and vacuum filtration. Thus, CNT networks are ideal candidates for various applications, such as thin-film transistors, diodes, strain and chemical sensors, field emission display devices, and transparent conducting electrodes. In particular, CNT transparent conducting electrodes (CNT-TCEs) may provide an important component of next generation flexible display devices due to their excellent electrical properties and mechanical flexibility.

While each of the individual CNTs has high electrical conductivity, the resistance at the intertube junctions among the CNTs in the CNT network has been an issue for commercializing CNT-TCEs.

### SUMMARY

In one aspect, structures comprising a CNT network and metal are disclosed herein. In accordance with one embodiment by way of non-limiting example, a structure may include a network of two or more CNTs having one or more intertube junctions among the two or more CNTs, and metal associated with the network of two or more CNTs, where a predominant amount of the metal is present at the one or more intertube junctions, and where the metal provides one or more bridges among the two or more CNTs.

In another aspect, the present disclosure provides methods for making a CNT network structure. In accordance with one embodiment by way of non-limiting example, one or more methods may involve providing metal to a network of two or more CNTs having one or more intertube junctions among the two or more CNTs, and applying an electrical current to the network of two or more CNTs, where the electrical current is provided between two electrodes associated with the network of two or more CNTs under conditions effective to produce one or more metal bridges at the one or more intertube junctions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A-B are schematic diagrams of an illustrative embodiment of a CNT network structure with metal bridging.

FIGS. 2A-C are schematic diagrams of an illustrative embodiment of a method for making a CNT network structure.

FIG. 3 is a schematic diagram of an illustrative embodiment of a CNT network structure detached from the substrate.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure may be arranged and designed in a wide variety of different configurations. Those of ordinary skill will appreciate that the functions performed in the methods may be implemented in differing order, and that the outlined steps are provided only as examples, and some of the steps may be optional, combined into fewer steps, or expanded to include additional steps while still being encompassed within the scope of the claims.

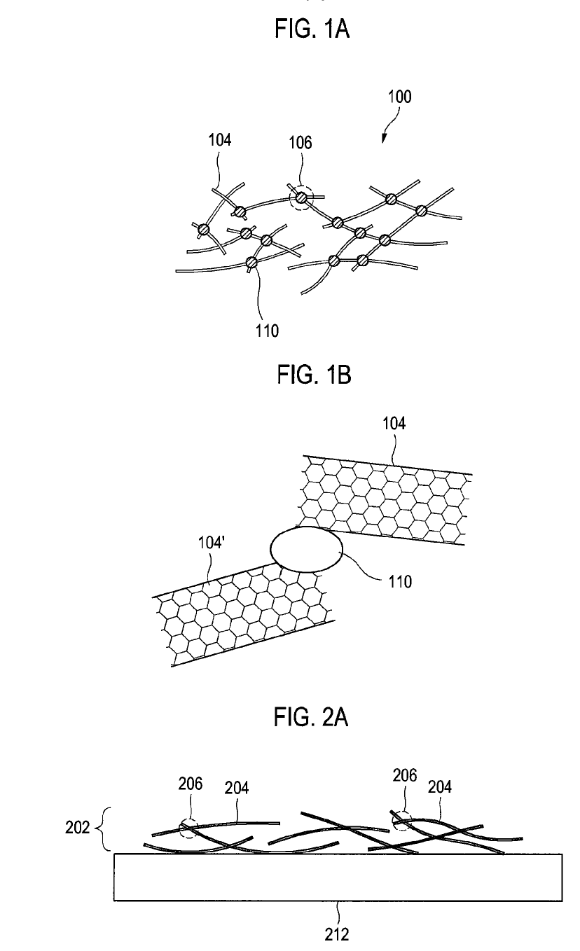

FIG. 1A is a schematic diagram of an illustrative embodiment of a CNT network structure with metal bridging. As used herein, the term “network” or “network structure” refers to a structure in which a plurality of CNTs cross, overlap with, and/or join one another at random, irregular, and/or regular intervals and/or positions. In some embodiments, the network structure 100 may include a plurality of CNTs 104 having one or more intertube junctions 106 among the two or more CNTs 104. In some embodiments, the network structure 100 may include two or more, three or more, four or more, five or more, six or more, seven or more, eight or more, nine or more, ten or more, etc. CNTs 104 having one or more intertube junctions 106.

As used herein, the term “junction” or “intertube junction” refers to a point or area where one or more CNT joins or crosses over another CNT. In some embodiments, the CNTs that cross and/or join are not in physical contact with one another, but are within a close physical proximity to one another, i.e., are close enough in distance such that a metal bridge can be formed in the area between the CNTs.

In some embodiments, the network structure 100 may include metal 110 associated with the plurality of CNTs 104, where a predominant amount of the metal 110 is present at the one or more intertube junctions 106, and where the metal 110 provides one or more bridges among the CNTs 104. As used herein, the term “bridge” refers to a metal that connects, links, or joins different CNTs at the intertube junctions, and also includes a metal present within the intertube junction that nearly touches and joins the different CNTs at the intertube junction but does not quite provide a direct connection. As used herein, the term “predominant amount” includes from about 50% to about 100% of the amount of metal associated with the entire CNT network. As used herein, the term “associated with the CNTs” may include metal that bridges, connects, links, or nearly joins the different CNTs at the intertube junctions of the CNT network, as well as metal in contact with or bound to portions of CNTs that are farther away from the intertube junctions.

FIG. 1B shows an illustrative embodiment of an intertube junction 106 between two CNTs 104, 104′ where the metal 110 associates, bridges, or connects the CNTs at the intertube junction 106. The metal bridges reduce the resistance at the intertube junctions, and improve the conductivity of the CNT network; the metal also reduces the transparency of the CNT network.

In some embodiments, the size and/or amount of the metal associated with the CNT network is selected such that the transparency of the CNT network structure is not substantially reduced. For example, a transparent conducting electrode typically has a visible light transmittance of about 80% or more. Thus, the size and/or amount of the metal associated with the CNT network included in a transparent conducting electrode may be selected such that the transparency of the CNT network structure or the transparent conducting electrode is reduced by e.g. 10% or less, or by 5% or less. Although the conductivity of a CNT network improves as the size of the metal increases, the transparency of the CNT network diminishes as the size and/or amount of the metal increases.

In some embodiments, the size of the metal present at the one or more intertube junctions may range from about 0.5 nm to about 20 nm in diameter or width/length. In some embodiments, the size of the metal may range from about 1 nm to about 20 nm, from about 2 nm to about 20 nm, from about 5 nm to about 20 nm, from about 7.5 nm to about 20 nm, from about 10 nm to about 20 nm, from about 15 nm to about 20 nm, from about 0.5 nm to about 1 nm, from about 0.5 nm to about 2 nm, from about 0.5 nm to about 5 nm, from about 0.5 nm to about 7.5 nm, from about 0.5 nm to about 10 nm, from about 0.5 nm to about 15 nm, from about 1 nm to about 2 nm, from about 2 nm to about 5 nm, from about 5 nm to about 7.5 nm, from about 7.5 nm to about 10 nm, or from about 10 nm to about 15 nm. In other embodiments, the size of the metal maybe about 0.5 nm, about 1.0 nm, about 5.0 nm, about 7.5 nm, about 10 nm, about 15 nm, or about 20 nm.

In some embodiments, a predominant amount of the metal 110 is present at the one or more intertube junctions 106, i.e., from about 50% to about 100%, from about 60% to about 100%, from about 70% to about 100%, from about 80% to about 100%, from about 90% to about 100%, from about 50% to about 60%, from about 50% to about 70%, from about 50% to about 80%, from about 50% to about 90%, from about 60% to about 70%, from about 70% to about 80%, from about 80% to about 90% of the metal 110 associated with the CNT network may be present at the one or more intertube junctions 106. In other embodiments, about 50%, about 60%, about 70%, about 80%, about 90%, or about 100% of the metal 110 associated with the CNT network may be present at the one or more intertube junctions 106.

Various types of metal may be used for the metal bridges in the present disclosure. In some embodiments, suitable metals include any metal capable of being electroplated to CNTs such as, but not limited to, Al, Cr, Co, Ni, Cu, Zn, Rh, Pd, Ag, Sn, W, Pt, Au, and Pb. In some embodiments, the metal may provide one or more metal-carbide bridges among the CNTs within the CNT network.

The metal present at the intertube junctions lowers the sheet resistance of the CNT network. For example, the metal-bridged CNT network structures in accordance with the illustrated embodiments described above may have sheet resistances ranging from about 10 Ω/sqto about 1000 Ω/sq. In some embodiments, the sheet resistance of the metal-bridged CNT network structures may range from about 50 Ω/sq to about 1000 Ω/sq, from about 100 Ω/sq to about 1000 Ω/sq, from about 200 Ω/sq to about 1000 Ω/sq, from about 300 Ω/sq to about 1000 Ω/sq, from about 500 Ω/sq to about 1000 Ω/sq, from about 10 Ω/sq to about 50 Ω/sq, from about 10 Ω/sq to about 100 Ω/sq, from about 10 Ω/sq to about 200 Ω/sq, from about 10 Ω/sq to about 300 Ω/sq, from about 10 Ω/sq to about 500 Ω/sq, from about 50 Ω/sq to about 100 Ω/sq, from about 100 Ω/sq to about 200 Ω/sq, from about 200 Ω/sq to about 300 Ω/sq, or from about 300 Ω/sq to about 500 Ω/sq. In other embodiments, the sheet resistance may be about 10 Ω/sq, about 50 Ω/sq, about 100 Ω/sq, about 200 Ω/sq, about 300 Ω/sq, 500 Ω/sq, or about 1000 Ω/sq.

In one aspect, transparent conducting electrodes including the CNT network structures described above are provided. The above illustrated CNT network structures, attached to a support or a substrate, are typically used as transparent conducting electrodes. Alternatively, the CNT network structure itself (without any support attached) may be used as a transparent conducting electrode. In general, transparent conducting electrodes should have a transmittance of at least about 80% within the range of visible light (380-780 mn), which may be measured using an ultraviolet-visible-near infrared (UV-VIS-NIR) spectrophotometer. The transparent conducting electrodes comprising the CNT network structures described herein may have a transmittance of at least about 80%, at least about 85%, at least about 90%, or at least about 95%, within the range of visible light. In some embodiments, the transparent conducting electrodes comprising the CNT network structures may have a transmittance of about 80%, about 85%, about 90%, about 95%, or about 100%, within the range of visible light.

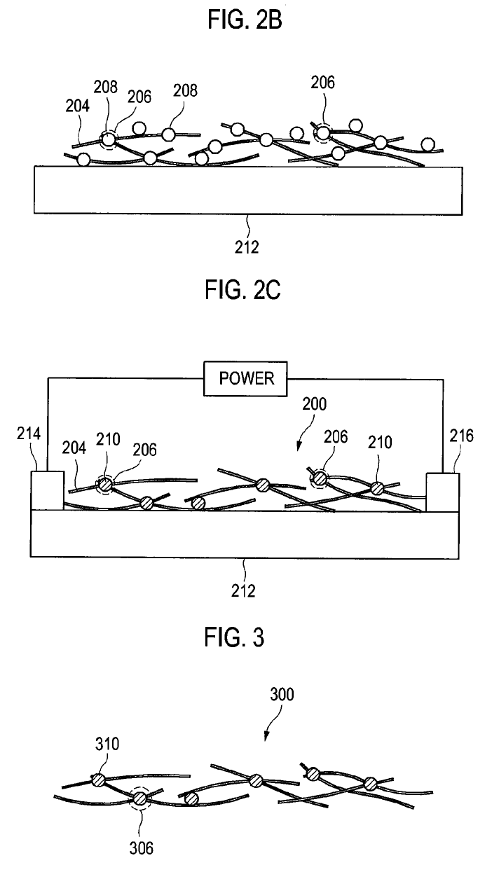

In another aspect, the present disclosure provides methods for making a CNT network structure. FIGS. 2A-C are schematic diagrams of an illustrative embodiment of a method for making a CNT network structure. In certain embodiments, the method may involve providing metal 208 to a CNT network 202 including CNTs 204 having one or more intertube junctions 206 among the CNTs 204, and applying an electrical current to the CNT network 202, where the electrical current is provided between two electrodes 214, 216 associated with the CNT network 202 under conditions effective to produce one or more metal bridges 210 at the one or more intertube junctions 206.

In some embodiments, the CNT network 202 may be formed on a substrate 212, prior to providing metal to the CNT network, as illustrated in FIG. 2A. Suitable substrates 212 include, but are not limited to, glass, glass wafer, silicon wafer, quartz, plastic, and transparent polymer. The surface of the substrate 212 may be treated for high wettability. Since a post-wet-process is required after the CNT network 202 is formed, a hydrophilic self assembled monolayer coating or a piranha (H₂SO₄:H₂O₂=4:1) treatment may be applied to increase the extent of the adhesion between the CNT network 202 and the substrate 212.

In some embodiments, the CNT network 202 may be prepared by using various techniques, such as dip-coating, spin coating, bar coating, spraying, self-assembly, Langmuir-Blodgett deposition, vacuum filtration, and the like.

When the dip-coating method is used to prepare the CNT network, the CNT colloidal solution may be prepared by dispersing purified CNTs in a solvent, such as deionized water or an organic solvent, for example, 1,2-dichlorobenzene, dimethyl formamide, benzene, methanol, and the like. Since the CNTs produced by the currently available methods may contain impurities, they may need to be purified before being dispersed into the solution. Alternatively, purified CNTs can be purchased directly. A suitable purification method may comprise refluxing CNTs in nitric acid (e.g., about 2.5 M) and re-suspending the CNTs in water with a surfactant (e.g., sodium lauryl sulfate, sodium cholate, and the like) at pH 10, and then filtering the CNTs using a cross-flow filtration system, for example. The resulting purified CNT suspension may then be passed through a filter, such as, but not limited to, a polytetrafluoroethylene filter.

The purified CNTs may be in a powder form that can be dispersed into the solvent. In certain embodiments, an ultrasonic wave or microwave treatment can be carried out to facilitate the dispersion of the purified CNTs throughout the solvent. The dispersing may be carried out in the presence of a surfactant. Various types of surfactants including, but not limited to, sodium dodecyl sulfate, sodium dodecylbenzenesulfonate, sodium dodecylsulfonate, sodium n-lauroylsarcosinate, sodium alkyl allyl sulfosuccinate, polystyrene sulfonate, dodecyltrimethylammonium bromide, cetyltrimethylarnmonium bromide, Brij, Tween, Triton X, and poly(vinylpyrrolidone), may be used. A well-dispersed and stable CNT mixture can thus be prepared.

Metal 208 is provided to the CNT network 202 (see, FIG. 2B). Various types of metals including, but not limited to Al, Cr, Co, Ni, Cu, Zn, Rh, Pd, Ag, Sn, W, Pt, Au, and Pb, may be used. At this step, the metal 208 may be in contact with the CNT network 202 throughout the entire CNT network 202. In some embodiments, the metal 208 may be provided to the CNT network 202 by spraying a metal-containing solution in the form of droplets, where the metal-containing droplets would be in contact with the CNT network 202. The metal 208 or metal-containing droplets may be randomly distributed throughout the entire CNT network 202, as illustrated in FIG. 2B.

Referring to FIG. 2C, an electrical current is applied to the CNT network 202 after metal 208 is provided to the CNT network 202. Two electrodes 214, 216 are associated with the CNT network 202, and an electrical current generated by a power supply is provided between the two electrodes 214, 216 so that the electrical current flows from one end of the CNT network 202 to the other end. When an electrical current is applied in this manner, the metal 208 provided to the CNT network 202 is electroplated primarily at the intertube junctions 206, whereby a predominant amount of the metal 208 associated with the CNT network 202 forms metal bridges 210 at the intertube junctions 206, as illustrated in FIG. 2C. The approximate ranges for the amount of the metal 110 present at the one or more intertube junctions 106 have already been described above. In some embodiments, the electrical current may be applied under vacuum conditions. After the electroplating of the metal 110, a metal-bridged CNT network 200 is produced, which may be washed with water or other solvents, e.g., H₂O₂ and alcohol, to remove the free metal from the CNT network 200.

Without intending to be bound by theory, it is believed that when an electrical current flows through the CNT network, negatively charged portions of the CNTs are concentrated at the intertube junctions, where electroplating of the positive metal ions from the metal-containing droplets takes place. Accordingly, metal is electroplated primarily at the intertube junctions of the CNT network. Moreover, due to the high resistance at the intertube junctions, a potential drop occurs at the intertube junctions, resulting in local heat generation at the intertube junctions. This local heat generation at the intertube junctions is thought to accelerate the electroplating at the intertube junctions. The electroplating of metal at the intertube junctions allows the CNT network structure of the present disclosure to have high transparency while maintaining low resistance. In contrast, if the metal is electroplated throughout the entire CNT network, the transparency of the CNT network structure would be considerably decreased.

The amount of metal present at the intertube junctions may be adjusted by controlling various conditions of the electroplating process, such as the electrical current density, the time of applying the electrical current, and the amount of impurities and defects on the CNT network.

For example, although the electrical current density may be varied depending on the amount of metal applied on the CNT network, the electrical current density may range from about 1 nA/cm² to about 10 A/cm². In some embodiments, the electrical current density may range from about 1 nA/cm² to about 1 μA/cm², from about 1 nA/cm² to about 1 mA/cm², from about 1 nA/cm² to about 1 A/cm², from about 1 μA/cm² to about 10 A/cm², from about 1 mA/cm² to about 10 A/cm², from about 1 A/cm² to about 10 A/cm², from about 1 μA/cm² to about 1 mA/cm², from about 1 mA/cm² to about 1 A/cm². In other embodiments, the electrical current density may be about 1 nA/cm², about 1 μA/cm², about 1 mA/cm², about 1 A/cm², or about 10 A/cm². If the electrical current density is lower than 1 nA/cm², a sufficient amount of metal may not be electroplated on the CNT network, and thus the desired conductivity of the CNT network may not be obtained. On the other hand, if the electrical current density is higher than 10 A/cm², too much metal may be electroplated on the CNT network, and the transparency of the CNT network may be severely lowered.

In some embodiments, it may also be desirable to vary the time of applying the electrical current depending on the amount of metal applied on the CNT network. The time of applying the electrical current may range from about 5 seconds to about 30 minutes. In some embodiments, the time of applying the electrical current may range from about 10 seconds to about 30 minutes, from about 30 seconds to about 30 minutes, from about 1 minute to about 30 minutes, from about 5 minutes to about 30 minutes, from about 10 minutes to about 30 minutes, from about 20 minutes to about 30 minutes, from about 5 seconds to about 10 seconds, from about 5 seconds to about 30 seconds, from about 5 seconds to about 1 minute, from about 5 seconds to about 5 minutes, from about 5 seconds to about 10 minutes, from about 5 seconds to about 20 minutes, from about 10 seconds to about 30 seconds, from about 30 seconds to about 1 minutes, from about 1 minutes to about 5 minutes, from about 5 minutes to about 10 minutes, or from about 10 minutes to about 20 minutes. In other embodiments, the time of applying the electrical current may be about 5 seconds, about 10 seconds, about 30 seconds, about 1 minute, about 5 minutes, about 10 minutes, about 20 minutes, or about 30 minutes. If the time is less than 5 seconds, a sufficient amount of metal may not be electroplated on the CNT network, and thus the desired conductivity of the CNT network may not be obtained. On the other hand, if the time is more than 30 minutes, too much metal may be electroplated on the CNT network, and the transparency of the CNT network may be severely lowered.

In some embodiments, after or while the electrical current is applied to the CNT network, heat may be applied to the CNT network to produce metal-carbide bridges between the metal and the CNT at the intertube junctions. Various transitional metal including, but not limited to Cr, Co, Ni, Cu, Zn, Rh, Pd, Ag, W, Pt, and Au, may form metal-carbide bridges with CNTs at the intertube junctions, when heat is applied to the CNT network. The suitable temperature and time for the heat treatment may vary depending on the properties (e.g., melting point, etc.) of the metals. The heat treatment may be carried out by placing the CNT network in an electric furnace, oven, or the like, at a temperature of from about 200° C. to about 800° C. In some embodiments, the temperature for the heat treatment may range from about 400° C. to about 800° C., from about 600° C. to about 800° C., from about 200° C. to about 400° C., from about 200° C. to about 600° C., or from about 400° C. to about 600° C. In other embodiments, the temperature for the heat treatment may be about 200° C., about 400° C., about 600° C., or about 800° C. The heat treatment may be carried out for a sufficient time to obtain metal-carbide bridges, for example, from about 5 seconds to 300 seconds. In some embodiments, the time for the heat treatment may range from about 10 seconds to about 300 seconds, from about 30 seconds to about 300 seconds, from about 60 seconds to about 300 seconds, from about 100 seconds to about 300 seconds, from about 200 seconds to about 300 seconds, from about 5 seconds to about 10 seconds, from about 5 seconds to about 30 seconds, from about 5 seconds to about 60 seconds, from about 5 seconds to about 100 seconds, from about 5 seconds to about 200 seconds, from about 10 seconds to about 30 seconds, from about 30 seconds to about 60 seconds, from about 60 seconds to about 100 seconds, or from about 100 seconds to about 200 seconds. In other embodiments, the time for the heat treatment may be about 5 seconds, about 10 seconds, about 30 seconds, about 60 seconds, about 100 seconds, about 200 seconds, or about 300 seconds. The metal-carbide bridges strengthen the CNT-metal coupling, thus increasing the mechanical properties of the CNT network, which may be measured using, for example, the methods set forth in the ASTM C 1557 Standard Test Method for Tensile Strength and Young's Modulus of Fibres.

Referring to FIG. 3, a schematic diagram of an illustrative embodiment of a CNT network structure 300 detached from the substrate 212 is shown. No special method or apparatus is required for detaching the CNT network from the substrate; for example, the CNT network may be detached from the substrate by hands. Although not intending to be bound by any theory, it is believed that the metal bridges 310 enhance the mechanical properties of the CNT network structure 300, allowing a freestanding CNT network structure 300 having metal bridges 310 at the intertube junctions 306 to be obtained. Such freestanding CNT network structures 300 exhibit high flexibility and transparency, where the freestanding CNT network structure 300 itself may be utilized as a TCE tape (i.e., TCE in a flexible tape form), a nanomembrane, and the like. A freestanding CNT network 300 having various sizes may be made depending on the application of the CNT network. For example, CNT networks having a size of about a few μm² can be manufactured for nanomembranes, while CNT networks having a size of about 1 m² or above can be manufactured for large scale display devices.

### EXAMPLES

The following examples are provided for illustration of some embodiments of the present disclosure but are by no means intended to limit its scope.

### Example 1

### Preparation of a CNT Network

First, a CNT colloidal solution is prepared. Sonication is conducted for about 30 minutes in nitric acid to purify the CNTs (product number: ASP-100F, Iljin Nanotech, Seoul, Korea). The CNTs are neutralized using deionized water after wet-oxidization, and then passed through a vacuum filtration device. The purified CNTs are dispersed in 1,2-dichlorobenzene. An ultrasonication treatment is carried out for about 10 hours to facilitate the dispersion of the purified CNTs throughout the solvent. As a result, a well dispersed and stable CNT colloidal solution is prepared.

Next, two metal electrodes consisting of Cr/Au are assembled on two opposite ends of a glass substrate. The substrate is treated with piranha (H₂SO₄:H₂O₂=4:1) to remove impurities from the surface of the substrate and modify the surface of the substrate so that it has polarity, thereby increasing the extent of adhesion between the CNTs and the substrate. Then, in order to form a CNT network on the substrate, dip coating is carried out by immersing the glass substrate vertically into the CNT colloidal solution prepared as described above with a withdrawal velocity of 0.3 mm/min at room temperature.

### Example 2

### Preparation of Metal Bridges within the CNT Network

Each of the two opposite ends of the above-prepared CNT network is connected to the electrodes on the glass substrate. Next, a solution consisting of 12 g/L of KAu(CN)₂ and 90 g/L of C₆H₅Na3O₇.2H₂O is sprayed to the CNT network. (Alternatively, Cu in a sulfuric acid bath (0.75 M of CuSO₄.5H₂O+74 g/L of H₂SO₄+0.2 g/L of gelatin) or Ni in a sulfamate-chloride bath (600 g/L of Ni(SO₃NH₂)₂.4H₂O+5 g/L of NiCl₂.6H₂O+45 g/L of H₃BO₃) may be sprayed to the CNT network.) As a result, Au-containing droplets are randomly distributed on the CNT network.

Then, an electrical current is applied to the CNT network between the two electrodes for 100 seconds at room temperature. An electrical current density of 0.1 A/cm² is applied. During this process, Au is electroplated on the CNT network, forming metal bridges predominantly at the intertube junctions. After the electroplating of Au, the CNT network structure is washed with water to remove the free Au from the CNT network structure.

The electrical resistance of the resulting CNT network structure is measured using a 4-point probe (model: CMT-SR2000N, AIT, Yongin, Korea), while the transparency of the resulting CNT network structure is measured using an ultraviolet-visible spectrophotometer (model: Lambda-20, Perkin Elmer, Waltham, Mass.).

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used herein is for the purpose of describing particular embodiments only, and is not intended to be limiting.

Those skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations while still encompassed by the claims.

The herein described subject matter sometimes illustrates different components contained within, or connected with, different other components. It is to be understood that such depicted architectures are merely illustrative, and that in fact many other architectures can be implemented which achieve the same functionality In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A structure comprising:
a network of two or more carbon nanotubes having one or more intertube junctions among the two or more carbon nanotubes; and
metal associated with the network of two or more carbon nanotubes, wherein a predominant amount of the metal is present at the one or more intertube junctions, and wherein the metal provides one or more bridges among the two or more carbon nanotubes.

2. The structure according to claim 1, wherein from about 90 to about 100% of the metal associated with the network of carbon nanotubes is present at the one or more intertube junctions.

3. The structure according to claim 1, wherein said structure has a sheet resistance of from about 10 Ω/sq to about 1000 Ω/sq.

4. The structure according to claim 1, wherein the size of the metal at the one or more intertube junctions ranges from about 0.5 nm to about 10 nm.

5. The structure according to claim 1, wherein the metal is selected from the group consisting of: Al, Cr, Co, Ni, Cu, Zn, Rh, Pd, Ag, Sn, W, Pt, Au, and Pb.

6. The structure according to claim 1, wherein the metal provides one or more metal-carbide bridges among the two or more carbon nanotubes.

7. A transparent conducting electrode comprising the structure according to claim 1.

8. A method for making a carbon nanotube network structure comprising:
providing metal to a network of two or more carbon nanotubes having one or more intertube junctions among the two or more carbon nanotubes; and
applying an electrical current to the network of two or more carbon nanotubes, wherein the electrical current is provided between two electrodes associated with the network of two or more carbon nanotubes under conditions effective to produce one or more metal bridges at the one or more intertube junctions.

9. The method according to claim 8, wherein said providing metal to a network of two or more carbon nanotubes comprises spraying a solution containing metal in the form of droplets.

10. The method according to claim 8, wherein said applying an electrical current to the network of two or more carbon nanotubes under conditions effective to produce one or more metal bridges at the one or more intertube junctions comprises providing an electrical current to the network of two or more carbon nanotubes at an electrical current density of from about 1 nA/cm² to about 10 A/cm².

11. The method according to claim 8, wherein said applying an electrical current to the network of two or more carbon nanotubes under conditions effective to produce one or more metal bridges at the one or more intertube junctions comprises providing an electrical current to the network of two or more carbon nanotubes for about 5 seconds to about 30 minutes.

12. The method according to claim 8, wherein the carbon nanotube network structure has a sheet resistance of from about 10 Ω/sq to about 1000 Ω/sq.

13. The method according to claim 8, wherein the size of the metal bridge at the one or more intertube junctions ranges from about 0.5 nm to about 10 nm.

14. The method according to claim 8, wherein the metal is selected from the group consisting of: Al, Cr, Co, Ni, Cu, Zn, Rh, Pd, Ag, Sn, W, Pt, Au, and Pb.

15. The method according to claim 8 further comprising forming the network of two or more carbon nanotubes on a substrate, prior to said providing metal.

16. The method according to claim 15, wherein the network of two or more carbon nanotubes is formed by dip-coating, spin coating, spraying, or vacuum filtration.

17. The method according to claim 15 further comprising detaching the carbon nanotube network structure having one or more metal bridges at the one or more intertube junctions from the substrate after said applying an electrical current, under conditions effective to obtain a freestanding carbon nanotube network structure.

18. The method according to claim 8 further comprising applying heat to the network of two or more carbon nanotubes after said applying an electrical current, under conditions effective to produce a metal-carbide bridge between the metal and the carbon nanotube at the one or more intertube junctions.

19. The method according to claim 18, wherein said applying heat to the network of two or more carbon nanotubes is carried out at a temperature of from about 200° C. to about 800° C.

20. The method according to claim 18, wherein said applying heat to the network of two or more carbon nanotubes is carried out for from about 5 seconds to 300 seconds.
